(19) United States
(12) Patent Application Publication
(10) Pub. No.: US 2005/0248664 A1
(43) Pub. Date: Nov. 10, 2005

(54) Identifying red eye in digital camera images

(75) Inventor: Amy D. Enge, Spencerport, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/841,743

(22) Filed: May 7, 2004

(51) Int. Cl. H04N 5/228; H04N 5/222

(52) U.S. Cl. 348/222.1; 348/370

(57) ABSTRACT

A method of detecting red eye in a color digital image produced by a digital camera includes using the digital camera to capture two original color digital images of the same scene with the first color digital image being with flash and the second color digital image without flash and producing for each such digital images a plurality of pixels in the same primary-color space having red, green, and blue pixels; and converting the primary-color space for the first and second digital images into the same chrominance channel, wherein the chrominance channel identifies a particular pair of colors and their relative intensity. The method further includes calculating the difference between the chrominance channel of the image captured without flash and the chrominance channel of the image captured with flash; and responding to such differences to locate the position of red eyes within the first color digital image.

### CROSS REFERENCE TO RELATED APPLICATION

Reference is made to commonly assigned U.S. patent application Ser. No. 10/792,079 filed Mar. 3, 2004, entitled “Correction Of Redeye Defects In Images Of Humans” by Andrew C. Gallagher et al, the disclosure of which is incorporated herein.

### FIELD OF THE INVENTION

The invention relates generally to the field of digital image processing, and in particular to red eye detection in color digital images by digital cameras.

### BACKGROUND OF THE INVENTION

Red eye in color digital images occurs when a flash illumination is reflected off a subject's retina and is captured by a camera. For humans this is usually a red color while for animals it is usually a red, green or yellow color. Many consumer cameras have a red-eye reduction flash mode that causes the subject's pupils to contract, thus reducing (but not eliminating) the red-eye effect. Other commercial methods have the user manually indicate the region of the red eye in the image to be corrected.

There are also many examples of semi-manual and automatic prior art in this field. U.S. Pat. No. 5,596,346 (Leone, et al.) discloses a semi-manual method of selecting the defect. The image is displayed on a touch sensitive display and the user can, by touching the display, maneuver a window to pan, zoom-in and zoom-out on particular portions of the image to designate a red-eye region. WO9917254 A1 (Boucher, et al.) discloses a method of detecting red eye based upon preset threshold values of luminance, hue and saturation. U.S. Pat. No. 6,292,574 B1 (Schildkraut, et al.) discloses a method of searching for skin colored regions in a digital image and then searching for the red-eye defect within those regions. U.S. Pat. No. 6,278,491 B1 (Wang, et al.) also discloses a method of redeye detection using face detection. British Patent 2,379,819 A (Nick) discloses a method of identifying highlight regions and associating these with specular reflections in red eye. U.S. Pat. No. 6,134,339 (Luo) discloses a method of detecting red-eye based on two consecutive images with an illumination source being fired during one of the images and not the other.

A significant problem with existing red eye detection methods is that they require considerable processing to detect red eye. Often they require separate scanning steps after a proposed red eye has been identified. These methods are often very computationally intensive and complex because they are not directly detecting red eye. These methods often have reduced success rates for detecting red eye because the success is based on the accuracy with which they can infer the red eye location from other scene cues. Another problem is that some of the methods require a pair of red eyes for detection. Another problem is that some of the red eye detection methods require user intervention and are not fully automatic. A significant problem with the red-eye reduction flash mode is the delay required between the pre-flash and the capture flash in order to appropriately reduce the red-eye effect. The red-eye reduction flash mode also does not completely eliminate the red-eye effect.

### SUMMARY OF THE INVENTION

It is an object of the present invention to provide an improved, automatic, computationally efficient way to detect red eye in color digital images.

This object is achieved by

It has been found that by using a digital camera in a flash and non-flash mode to capture the same image of a scene that red eye can be more effectively detected by converting the primary-color space for the first and second digital images into the same chrominance channel, wherein the chrominance channel identifies a particular pair of colors and their relative intensity. Thereafter by calculating the difference between the chrominance channel of the image captured without flash and the chrominance channel of the image captured with flash; and responding to such differences to locate the position of red eyes within the first color digital image.

### BRIEF DESCRIPTION OF THE DRAWINGS

FIG. 1 is a perspective of a computer system including a digital camera for implementing the present invention;

FIG. 2 is a block diagram showing the flash and non-flash images captured by the digital camera;

FIG. 3 is a block diagram of the red eye location operation;

FIG. 4 is a more detailed block diagram of block 204 in FIG. 3 with thresholding;

FIG. 5 is a more detailed block diagram of block 204 in FIG. 3 without thresholding;

FIGS. 6A and 6B are block diagrams of the chrominance channel calculation;

FIG. 7 is a block diagram of the chrominance difference process;

FIG. 8 is a block diagram of the threshold step;

FIG. 9 is a general block diagram including the threshold step without a levels threshold step;

FIG. 10 is a block diagram of the threshold step without a color threshold step;

FIG. 11 is a block diagram of the threshold step with a shape threshold step;

FIG. 12 is a block diagram of the threshold step with a shape threshold step but without a levels threshold step;

FIG. 13 is a block diagram of the threshold step with a shape threshold step but without a color threshold step;

FIG. 14 is a block diagram of the threshold step with a shape threshold step but without a levels threshold step and a color threshold step;

FIG. 15 is a block diagram of the color threshold step with a region adjustment step;

FIG. 16 is a block diagram of the color threshold step with a region adjustment but without a low threshold step;

FIG. 17 is a block diagram of the color threshold step with a region adjustment using the flash image; and

FIG. 18 is a block diagram of the color threshold step with a region adjustment using the flash image but without a low threshold step.

### DETAILED DESCRIPTION OF THE INVENTION

In the following description, a preferred embodiment of the present invention will be described in terms that would ordinarily be implemented as a software program. Those skilled in the art will readily recognize that the equivalent of such software may also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware and/or software for producing and otherwise processing the image signals involved therewith, not specifically shown or described herein, may be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program may be stored in a computer readable storage medium, which may comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such a personal computer. Consequently, the computer system will not be discussed in detail herein. It is also instructive to note that the images are either directly input into the computer system (for example by a digital camera) or digitized before input into the computer system (for example by scanning an original, such as a silver halide film).

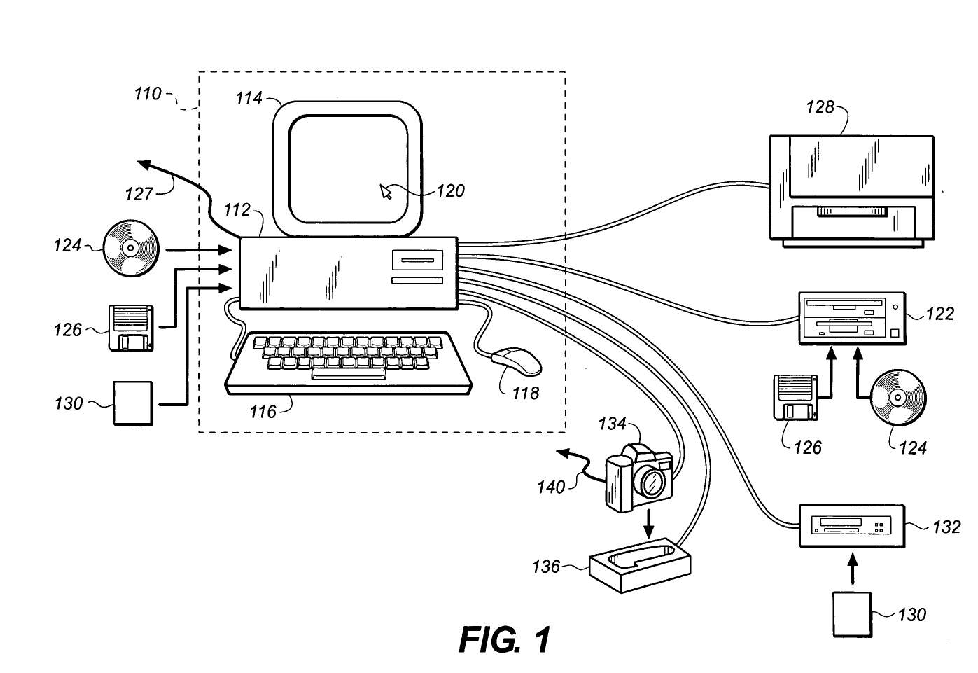

Referring to FIG. 1, there is illustrated a computer system 110 for implementing the present invention. Although the computer system 110 is shown for the purpose of illustrating a preferred embodiment, the present invention is not limited to the computer system 110 shown, but may be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 may be used for moving a selector 120 on the display 114 and for selecting an item on which the selector 120 overlays, as is well known in the art.

A compact disk-read only memory (CD-ROM) 124, which typically includes software programs, is inserted into the microprocessor based unit 112 for providing a means of inputting the software programs and other information to the microprocessor-based unit 112. In addition, a floppy disk 126 may also include a software program, and is inserted into the microprocessor-based unit 112 for inputting the software program. The compact disk-read only memory (CD-ROM) 124 or the floppy disk 126 may alternatively be inserted into an externally located disk drive unit 122 which is connected to the microprocessor-based unit 112. Still further, the microprocessor-based unit 112 may be programmed, as is well known in the art, for storing the software program internally. The microprocessor-based unit 112 may also have a network connection 127, such as a telephone line, to an external network, such as a local area network or the Internet. A printer 128 may also be connected to the microprocessor-based unit 112 for printing a hardcopy of the output from the computer system 110.

Images may also be displayed on the display 114 via a personal computer card (PC card) 130, such as, as it was formerly known, a PCMCIA card (based on the specifications of the Personal Computer Memory Card International Association) which contains digitized images electronically embodied in the card 130. The PC card 130 is ultimately inserted into the microprocessor based unit 112 for permitting visual display of the image on the display 114. Alternatively, the PC card 130 can be inserted into an externally located PC card reader 132 connected to the microprocessor-based unit 112. Images may also be input via the compact disk 124, the floppy disk 126, or the network connection 127. Any images stored in the PC card 130, the floppy disk 126 or the compact disk 124, or input through the network connection 127, may have been obtained from a variety of sources, such as a digital camera (not shown) or a scanner (not shown). Images may also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, the algorithm may be stored in any of the storage devices heretofore mentioned and applied to images in order to detect red eye in images.

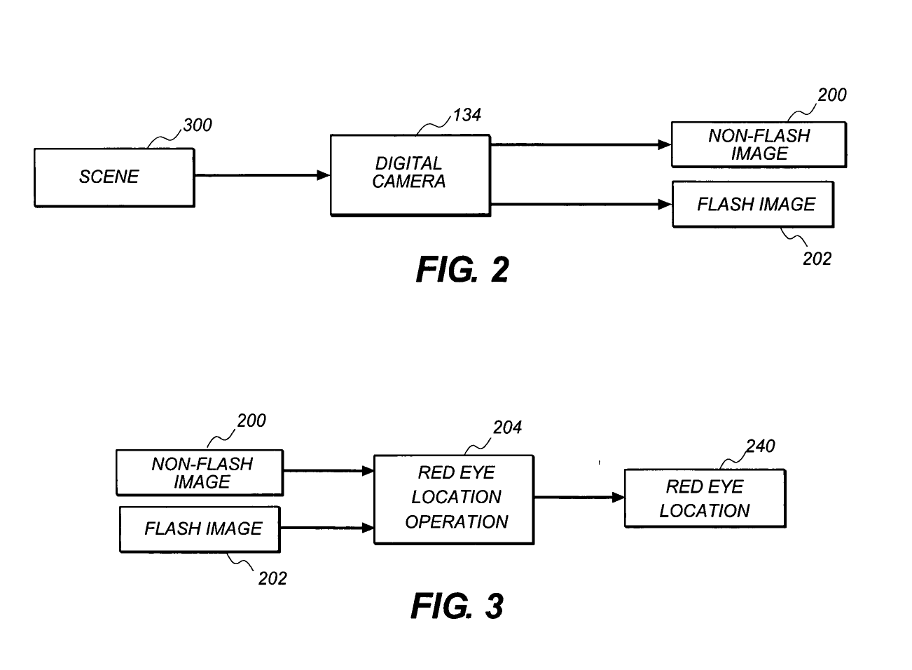

Referring to FIG. 2, the digital camera 134 is responsible for creating the original flash image 202 and non-flash image 200 in a primary color space from the scene 300. Examples of typical primary-color spaces are red-green-blue (RGB) and cyan-magenta-yellow (CMY).

FIG. 3 is a high level diagram of the preferred embodiment. The flash image 202 and non-flash (i.e., without flash) image 200 are processed through the red eye location operation 204. The result is a red eye location 240.

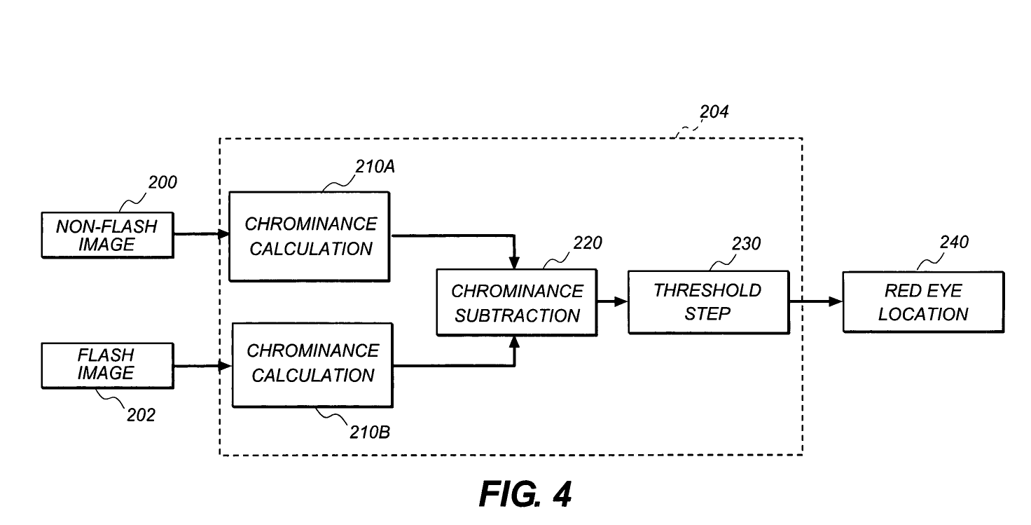

Referring to FIG. 4, the red eye location operation 204 is subdivided into a chrominance calculation 210, a chrominance subtraction 220, and a threshold step 230.

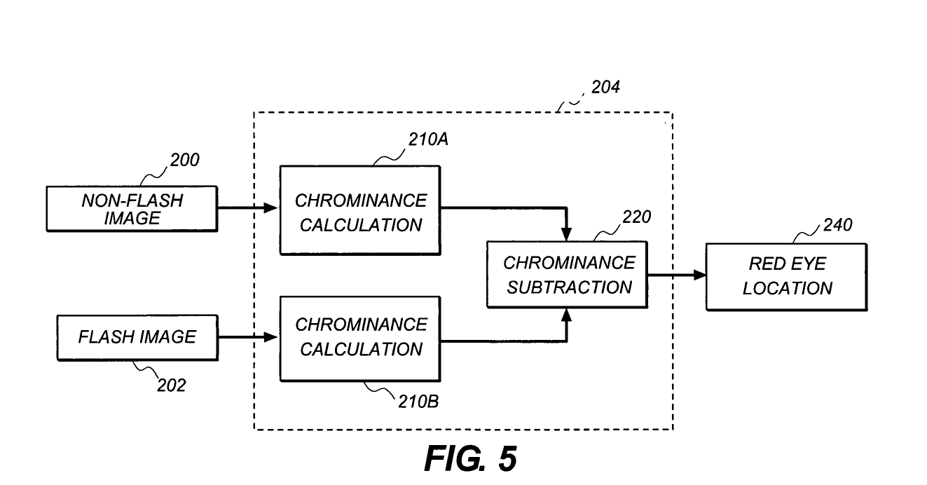

Although FIG. 4 shows the red eye location operation 204 including three steps (i.e., the steps 210-230), it is to be noted that the red eye location operation 204 can operate with fewer steps. For example, referring to FIG. 5, in an alternate embodiment, the red eye location operation 204 does not include the threshold step 230. In this case, the red eye location 240 is directly populated with the result from the chrominance subtraction 220.

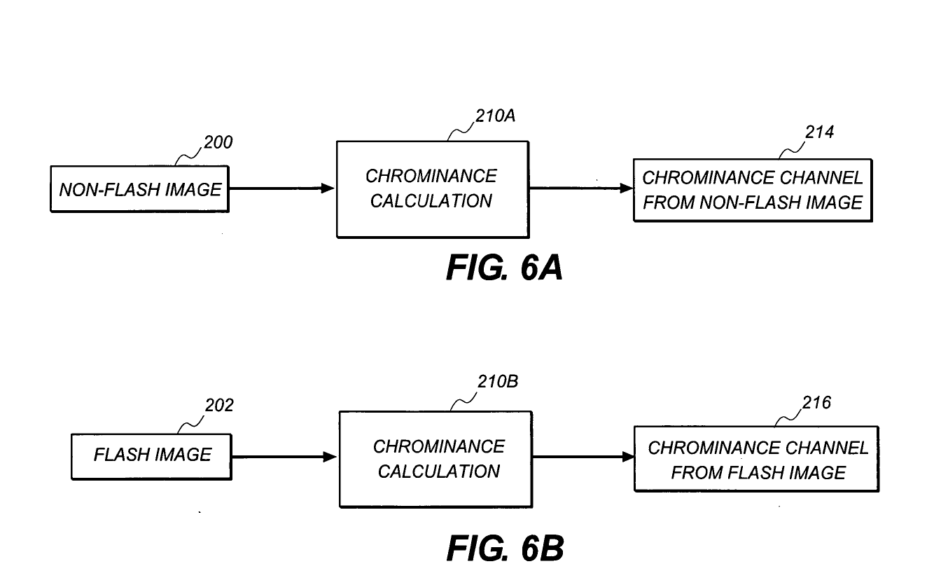

Returning to the preferred embodiment, FIG. 6A and FIG. 6B are detailed diagrams of the chrominance calculation 210A and chrominance calculation 210B. The chrominance calculation for the preferred embodiment, which assumes RGB flash image 202 and RGB non-flash image 200, is

$$C = \frac{2 G - R - B}{4}$$

where R=red, G=green, B=blue, and C=the chrominance channel. It should be clear to others skilled in the art that other chrominance calculations could be used. For example, if animal red eye (that is visually yellow) is to be detected, an appropriate chrominance calculation would be

$$C = \frac{B - R}{2} .$$

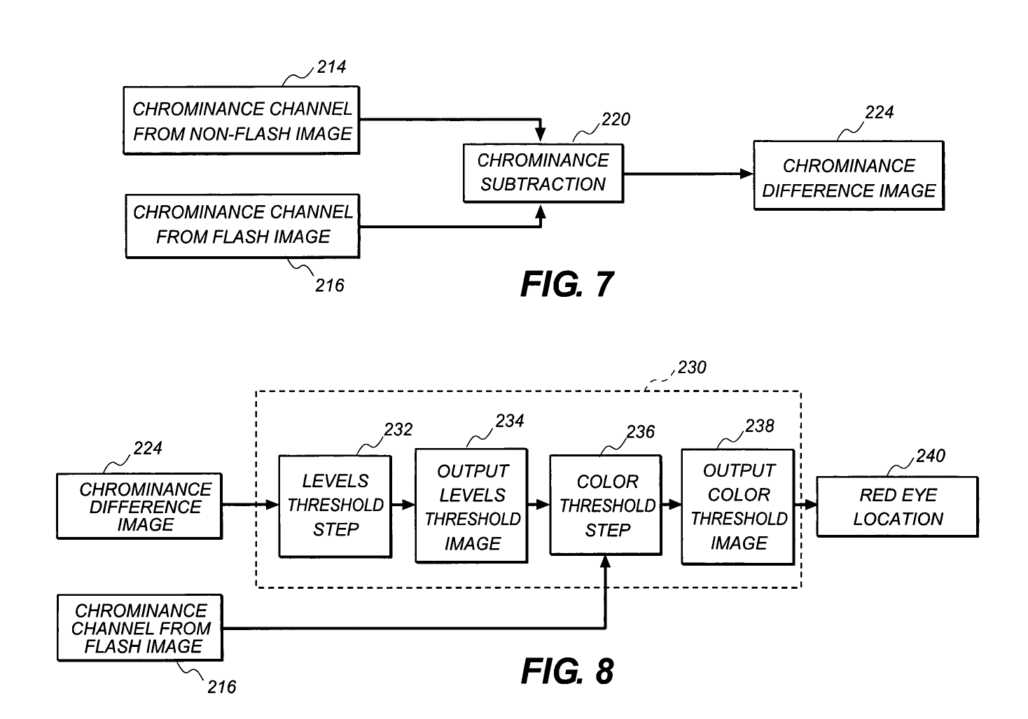

Referring to FIG. 7, the output from the chrominance calculation, chrominance channel from non-flash image 214 and chrominance channel from flash image 216, is sent to the chrominance subtraction 220. The calculation for the preferred embodiment is
C₂₂₄=C₂₁₆−C₂₁₄
Where C₂₂₄ is the chrominance difference image 224 pixel value, C₂₁₄ is the chrominance channel from non-flash image 214 pixel value and C₂₁₆ is the chrominance channel from flash image 216 pixel value. The result of the chrominance subtraction 220 is the chrominance difference image 224.

FIG. 8 shows the details of threshold step 230. The purpose of a levels threshold step 232 is to determine if the calculated chrominance difference pixel value is large enough to indicate a red eye location. The levels threshold step 232 is applied to chrominance difference image 224. The levels threshold step 232 compares the pixel values in the chrominance difference image 224 to a predetermined levels threshold value. Pixel values in the chrominance difference image 224 that are less than the predetermined levels threshold value are assigned to zero in the output levels threshold image 234. Pixel values that are not less than the predetermined levels threshold value are assigned unaltered to the output levels threshold image 234. The resulting output levels threshold image 234 is refined by the color threshold step 236. Also required for the color threshold step 236 is the chrominance channel from flash image 216. The purpose of the color threshold step 236 is to determine if the pixel value is substantially red (or green or yellow for animal eyes). For each non-zero value in the output levels threshold image 234, the color threshold step 236 will examine the corresponding location in the chrominance channel from flash image 216. For pixel values in the chrominance channel from flash image 216 that are less than the predetermined color threshold value, the corresponding pixel values in the output color threshold image 238 are assigned to zero. The remaining pixel values that are not less than the predetermined color threshold value are assigned unaltered from the output levels threshold image 234 to the output color threshold image 238. The pixel values in the output color threshold image 238 are assigned unaltered to the red eye location 240.

A typical value for the aforementioned predetermined levels threshold value for an 8-bit image is 5. A typical value for the aforementioned predetermined color threshold value for an 8-bit image is 30.

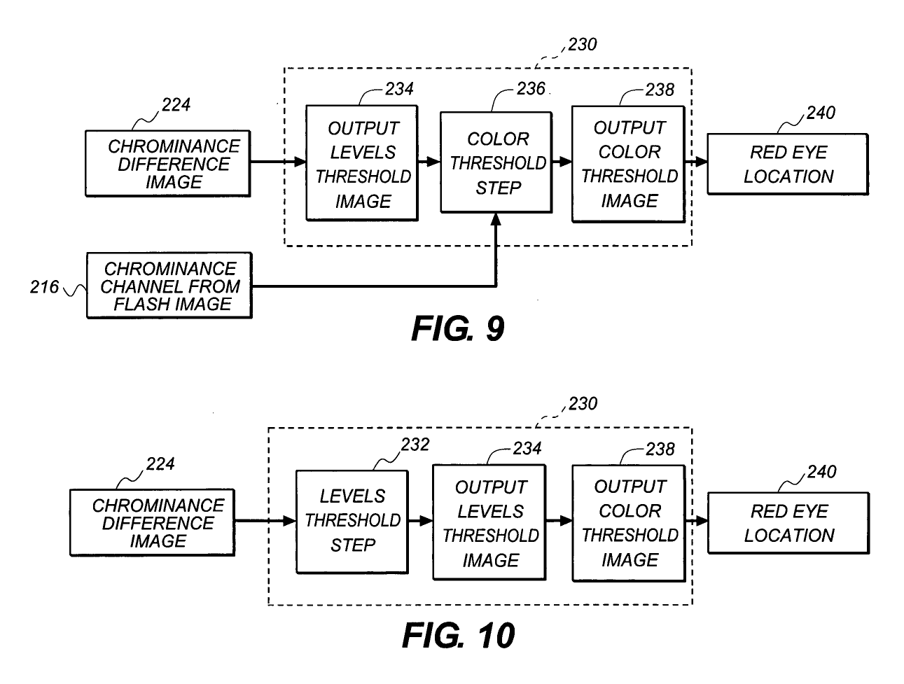

Although FIG. 8 shows that threshold step 230 includes four steps (i.e., the steps 232-238), it is to be noted that the threshold step 230 can operate with fewer steps. For example, referring to FIG. 9, the threshold step 230 does not include the levels threshold step 232 (FIG. 8). In this case, pixel values in the chrominance difference image 224 are assigned unaltered to the output levels threshold image 234. As a further example, referring to FIG. 10, the threshold step 230 does not include the color threshold step 236. In this case, pixel values in the output levels threshold image 234 are assigned unaltered to the output color threshold image 238.

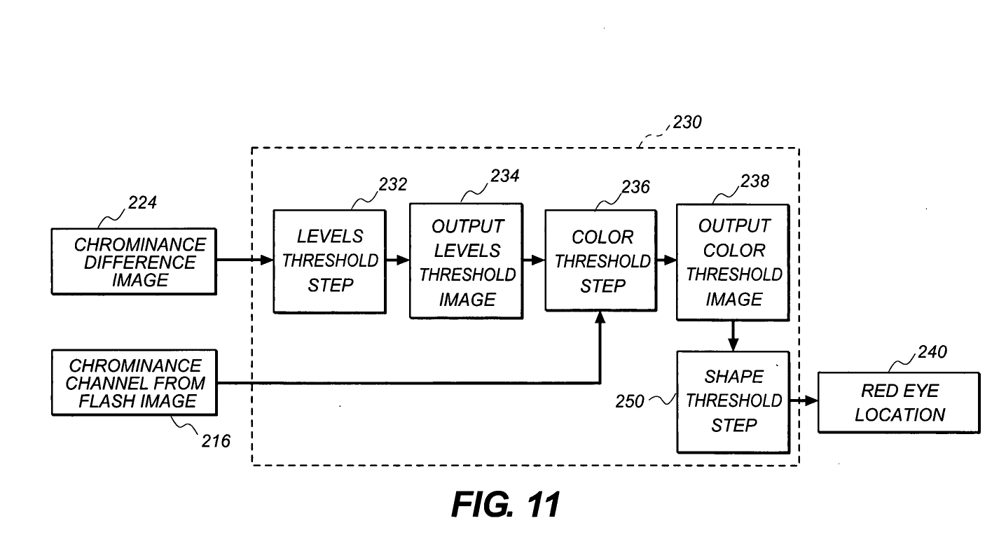

FIG. 11 shows the details of the threshold step 230 for another embodiment of the invention. The details are the same as those described for FIG. 8 except that the pixel values in the output color threshold image 238 are further refined by the shape threshold step 250. The purpose of the shape threshold step 250 is to determine if the red eye is substantially circular to confirm that red eye has been detected. For pixel values in the output color threshold image 238 that are greater than zero, the pixel coordinates are grouped to determine the shape. The shape of the grouped pixel coordinates is compared to a predetermined shape threshold in the shape threshold step 250. For pixel coordinates that meet the shape threshold step 250 requirements, the pixel value is assigned unaltered to the red eye location 240. For pixel coordinates that do not meet the shape threshold step 250 requirements, the pixel value is assigned to zero in the red eye location 240.

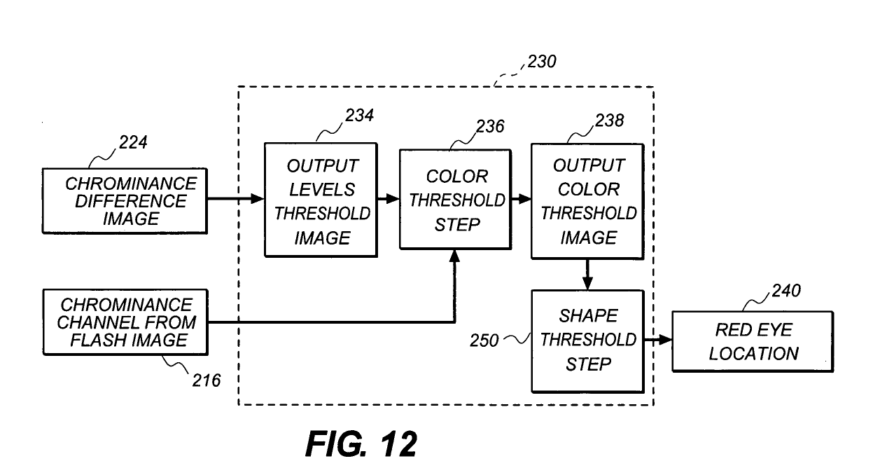

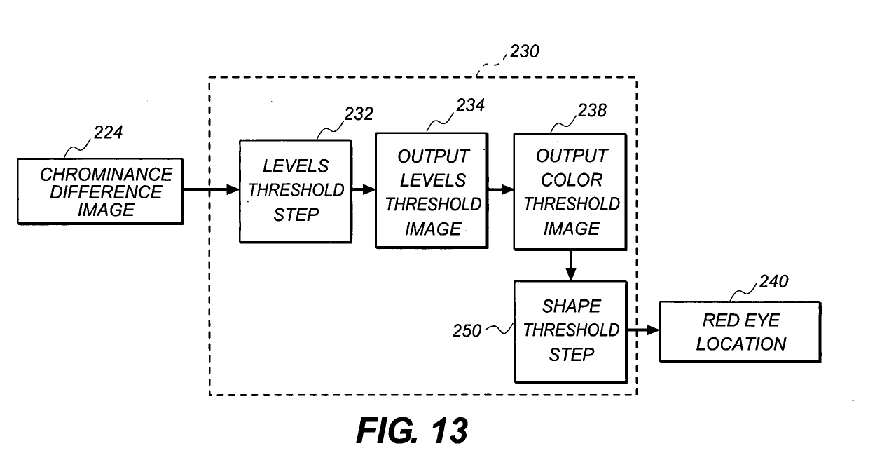

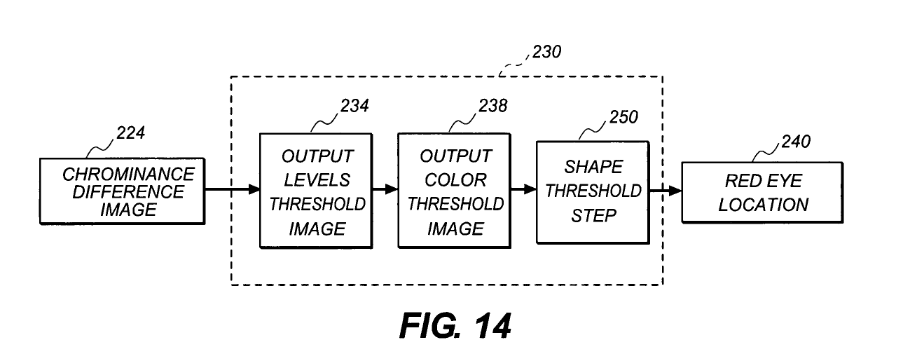

Although FIG. 11 shows the threshold step 230 includes five steps (i.e., the steps 232-250), it is to be noted that the threshold step 230 can operate with fewer steps. For example, referring to FIG. 12, the threshold step 230 does not include the levels threshold step 232. In this case, pixel values in the chrominance difference image 224 are assigned unaltered to the output levels threshold image 234. As a further example, referring to FIG. 13, the threshold step 230 does not include the color threshold step 236. In this case, pixel values in the output levels threshold image 234 are assigned unaltered to the output color threshold image 238. As a further example, referring to FIG. 14, the threshold step 230 does not include the levels threshold step 232 or the color threshold step 236. In this case, pixel values in the chrominance difference image 224 are assigned unaltered to the output levels threshold image 234. Pixel values in the output levels threshold image 234 are assigned unaltered to the output color threshold image 238.

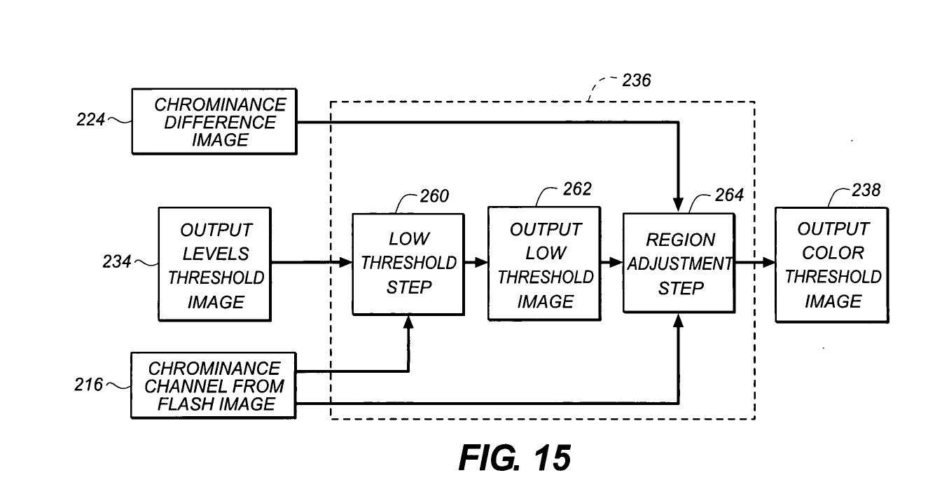

FIG. 15 shows the details for the color threshold 236 in another embodiment of the invention. The purpose of a low threshold step 260 is to determine if the pixel value is substantially red (or green or yellow for animal eyes). For each non-zero value in the output levels threshold image 234, the low threshold step 260 will examine the corresponding location in the chrominance channel from flash image 216. For pixel values in the chrominance channel from flash image 216 that are less than the predetermined low threshold value, the corresponding pixel values in an output low threshold image 262 are assigned to zero. The remaining pixel values that are not less than the predetermined color threshold value are directly assigned from the output levels threshold image 234 to the output low threshold image 262. The pixel values in the output low threshold image 262 are further refined by a region adjustment step 264. Also required for the region adjustment step 264 is the chrominance channel from flash image 216 and the chrominance difference image 224. The purpose of the region adjustment step 264 is to examine pixels adjacent to the detected red eye to determine if they should be included in the detected red eye. For each non-zero value in the output low threshold image 262, the region adjustment step 264 will examine the corresponding surrounding pixel values in the chrominance channel from flash image 216. For pixel values in the chrominance channel from flash image 216 that are greater than the predetermined region adjustment value, the corresponding pixel values in the chrominance difference image 224 are assigned unaltered to the output color threshold image 238. The remaining pixel values that are not greater than the predetermined color threshold value are assigned unaltered from the output low threshold image 262 to the output color threshold image 238.

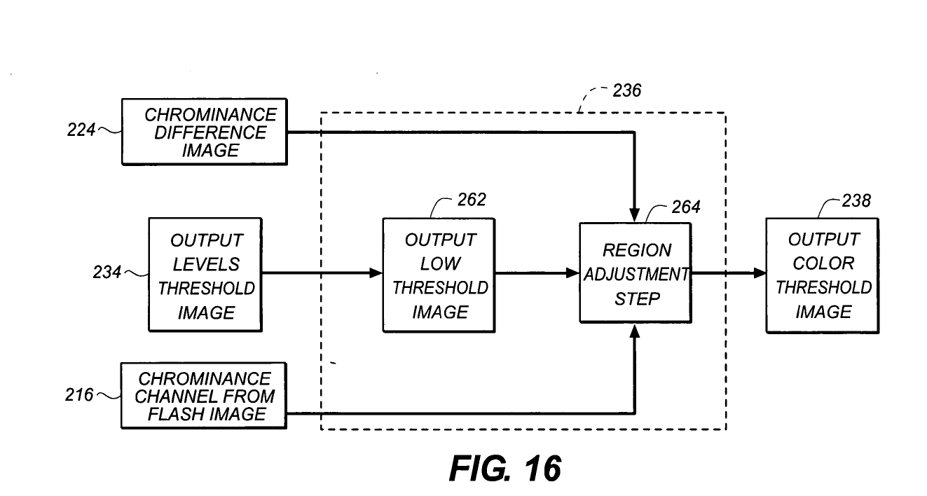

Although FIG. 15 includes three steps, (i.e. the steps 260-264), it is to be noted that the color threshold step 236 can operate with fewer steps. For example, referring to FIG. 16, the color threshold step 236 does not include the low threshold step 260. In this case, the pixel values in the output levels threshold 234 are assigned unaltered to the output low threshold.

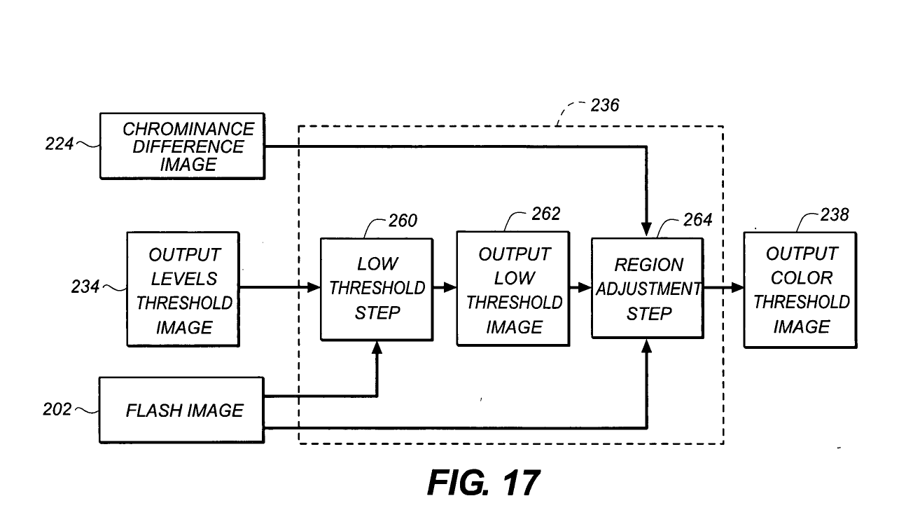

Although FIG. 15 shows the pixel values of the pixel coordinates of the chrominance channel from flash image 216 being compared to a predetermined value given in the low threshold step 262; FIG. 17 shows that the flash image 202 is used instead of the chrominance channel from the flash image 216.

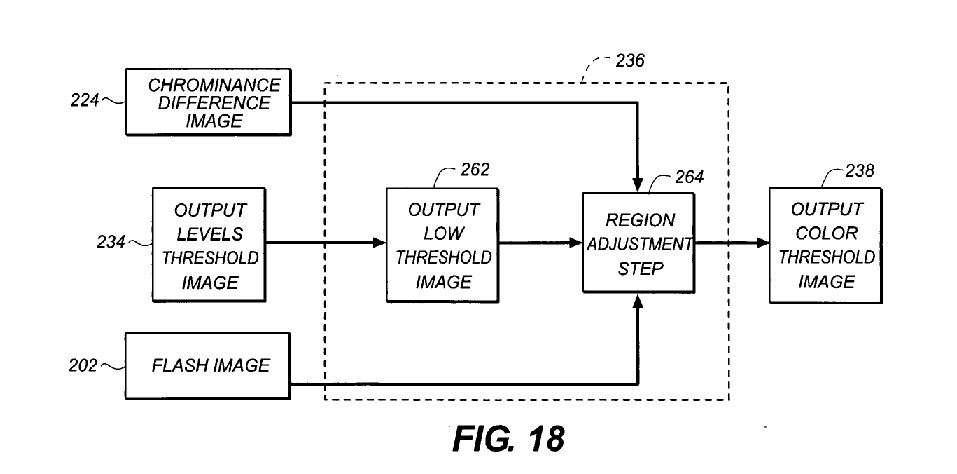

Although FIG. 17 includes three steps, (i.e. the steps 260-264), it is to be noted that the color threshold step 236 can operate without some of the steps 260-264. For example, referring to FIG. 18, the color threshold step 236 does not include the low threshold step 260. In this case, the pixel values in the output levels threshold image 234 are assigned unaltered to the output low threshold image 262.

The red eye detection algorithm disclosed in the preferred embodiment(s) of the present invention may be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that can be used as a processing unit, a display unit, or a unit to give processing instructions), and as a service offered via the World Wide Web.

In each case, the red-eye algorithm may stand alone or may be a component of a larger system solution. Furthermore, the interfaces with the algorithm, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the algorithm itself can be fully automatic, may have user input (be fully or partially manual), may have user or operator review to accept/reject the result, or may be assisted by metadata (metadata that may be user supplied, supplied by a measuring device (e.g. in a camera), or determined by an algorithm). Moreover, the algorithm may interface with a variety of workflow user interface schemes.

The red-eye detection algorithm disclosed herein in accordance with the invention can also be employed with interior components that utilize various data detection and reduction techniques (e.g., face detection, eye detection, skin detection, flash detection)

The invention has been described in detail with particular reference to certain preferred embodiments thereof, but it will be understood that variations and modifications can be effected within the spirit and scope of the invention.

1. A method of detecting red eye in a color digital image produced by a digital camera, comprising:
(a) using the digital camera to capture two original color digital images of the same scene with the first color digital image being with flash and the second color digital image without flash and producing for each such digital images a plurality of pixels in the same primary-color space having red, green, and blue pixels;
(b) converting the primary-color space for the first and second digital images into the same chrominance channel, wherein the chrominance channel identifies a particular pair of colors and their relative intensity;
(c) calculating the difference between the chrominance channel of the image captured without flash and the chrominance channel of the image captured with flash; and
(d) responding to such differences to locate the position of red eyes within the first color digital image.

2. The method of claim 1 wherein the responding step includes performing a threshold step on the chrominance channel differences to separate, based on brightness, red eye from other similarly colored objects in the scene;

3. The method of claim 2 wherein the threshold step includes comparing the pixel values of the chrominance channel differences image or the first color digital image to a predetermined value.

4. The method of claim 2 wherein the threshold step includes comparing the chrominance pixel values of the first color digital image color or the chrominance channel of the first color digital image to a predetermined value.

5. The method of claim 2 wherein the threshold step includes selecting pixels adjacent to the detected red eye to determine if the red eye is substantially circular to confirm that red eye has been detected.

6. The method of claim 1 further including examining the pixels in the first color digital image or the chrominance channel of the first color digital image adjacent to the detected red eye to determine if they should be included in the detected red eye.

7. A method of detecting red eye in a color digital image produced by a digital camera:
(a) using the digital camera to capture two original color digital images of the same scene with the first color digital image being with flash and the second color digital image without flash and producing for each such digital images a plurality of pixels in the same primary-color space having red, green, and blue pixels;
(b) converting the primary-color space for the first and second digital images into the same chrominance channel, wherein the chrominance channel is defined by
$$C = \frac{2 G - R - B}{4}$$
where R=red, G=green, B=blue, and C=the chrominance channel;
(c) calculating the difference between the chrominance channel of the image captured without flash and the chrominance channel of the image captured with flash; and
(d) responding to such differences to locate the position of red eyes within the first color digital image.

8. The method of claim 7 wherein the responding step includes performing a threshold step on the chrominance channel differences to separate, based on brightness, red eye from other similarly colored objects in the scene;

9. The method of claim 8 wherein the threshold step includes comparing the pixel values of the chrominance channel differences image or the first color digital image to a predetermined value.

10. The method of claim 8 wherein the threshold step includes comparing the chrominance pixel values of the first color digital image color or the chrominance channel of the first color digital image to a predetermined value.

11. The method of claim 8 wherein the threshold step includes selecting pixels adjacent to the detected red eye to determine if the red eye is substantially circular to confirm that red eye has been detected.

12. The method of claim 7 further including examining the pixels in the first color digital image or the chrominance channel of the first color digital image adjacent to the detected red eye to determine if they should be included in the detected red eye.
